(19) United States
(12) Patent Application Publication
(10) Pub. No.: US 2014/0176699 A1
(43) Pub. Date: Jun. 26, 2014

(54) DRIVING ASSISTANT SYSTEM AND METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: KANG-BIN WANG, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 13/963,132

(22) Filed: Aug. 9, 2013

(30) Foreign Application Priority Data
Dec. 22, 2012 (CN) 2012105617738

(51) Int. Cl. H04N 5/232; B60R 11/04

(52) U.S. Cl. CPC H04N 5/23238; B60R 11/04
USPC 348/118

(57) ABSTRACT

A driving assistant system comprises a plurality of cameras configured to capture pictures around a vehicle in different positions and directions and a monitor to display the pictures. The driving assistant system further comprises a FPGA connected to the plurality of cameras. The FPGA combines the pictures into a panorama picture and send the panorama picture to the monitor which displays the panorama picture. The present disclosure further discloses a driving assistant method based upon the above driving assistant system.

### CROSS-REFERENCE TO RELATED APPLICATIONS

This application are related to co-pending application entitled, “DRIVING ASSISTANT SYSTEM AND METHOD”, filed on ***, application No. ***, (Atty. Docket No. US48636), and “DRIVING ASSISTANT SYSTEM AND METHOD”, filed on ***, application No. ***, (Atty. Docket No. US48637).

### BACKGROUND

1. Technical Field

The present disclosure relates to a driving assistant system and method.

2. Description of Related Art

For safety while driving automotive vehicles, a small camera is mounted on a vehicle and directed to a specific direction to take an image not directly viewed by a driver. The taken image is displayed on a monitor of the vehicle. However, the camera cannot take images surrounding each side of the vehicle and blind spots.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a driving assistant system.

FIGS. 2 and 3 illustrate a flow chart of an embodiment of a driving assistant method.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean “at least one.”

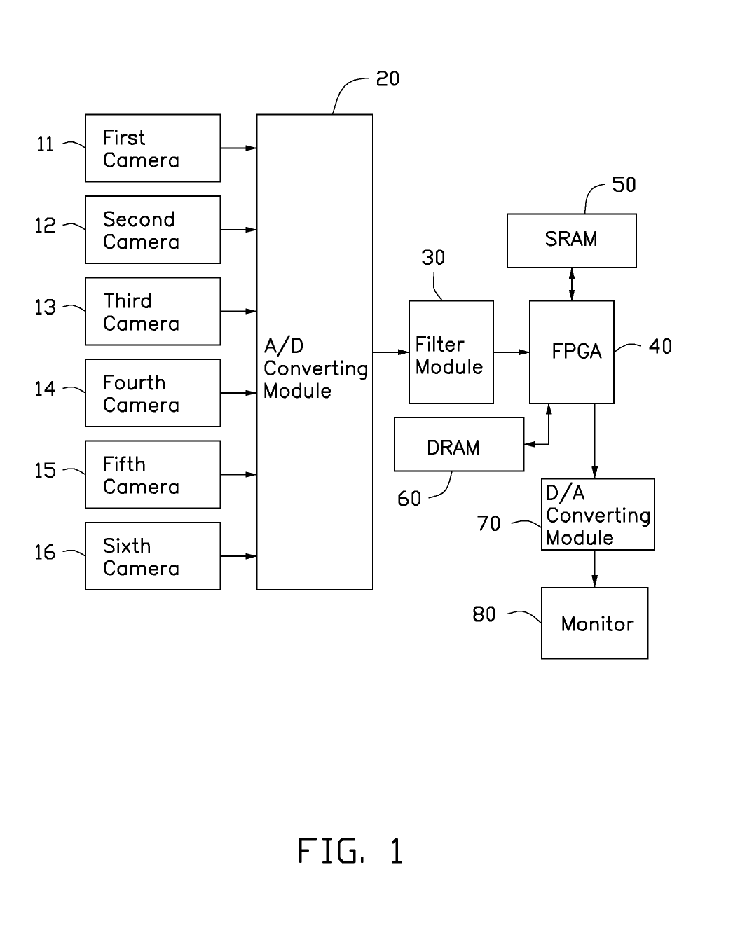

FIG. 1 shows an embodiment of a driving assistant system comprising a plurality of cameras, an analog-to-digital (A/D) converting module 20, a filter module 30, a Field-Programmable Gate Array (FPGA) 40, a Static Random Access Memory (SRAM) 50, a Dynamic Random Access memory (DRAM) 60, a digital-to-analog (D/A) converting module 70, and a monitor 80. The plurality of cameras comprises a first camera 11, a second camera 12, a third camera 13, a fourth camera 14, a fifth camera 15, a sixth camera 16. Each of the plurality of cameras is connected to the A/D converting module 20. The filter module 30 is connected to the A/D converting module 20. The FPGA 40 is connected to the filter module 30. The SRAM 50 is connected to the

FPGA 40. The DRAM 60 is connected to the FPGA 40. The D/A converting module 70 is connected to the FPGA 40. The monitor 80 is connected to the D/A converting module 70.

In one embodiment, the driving assistant system is used for a large vehicle such as a load vehicle. The first camera 11 and the second camera 12 are attached to two front corners of the vehicle. The third camera 13 and the fourth camera 14 are attached to opposite sides of the vehicle and are positioned adjacent to a central portion of the vehicle. The fifth camera 15 and the sixth camera 16 are attached to two rear corners of the vehicle. Each of the plurality of cameras is a wide-angle lens camera (e.g., 170 degrees lens). The plurality of cameras can take images around the vehicle, thus virtually eliminating blind spots around the vehicle.

Each of the plurality of cameras comprises a fish-eye lens to capture a fish-eye image around the vehicle. The fish-eye image comprises analog picture signals which carry information of the fish-eye image. The A/D converting module 20 converts analog picture signals to digital picture signals. The digital picture signals is filtered by the filter module 30 and sent to the FPGA 40. The FPGA 40 converts the digital picture signals indicative of the fish-eye image into converted digital picture signals indicative of a plane image. Thus, the fish-eye image can be converted to the plane image. The FPGA 40 combines the converted digital picture signals coming from the plurality of cameras to get a panorama image which provides a 360° view around the vehicle. The combined digital picture signals are converted to analog picture signals by the D/A converting module 70 and sent to the monitor 80. The monitor 80 displays the panorama image.

The SRAM 50 and the DRAM 60 are connected to the FPGA 40 and help the FPGA 40 to store static and dynamic data.

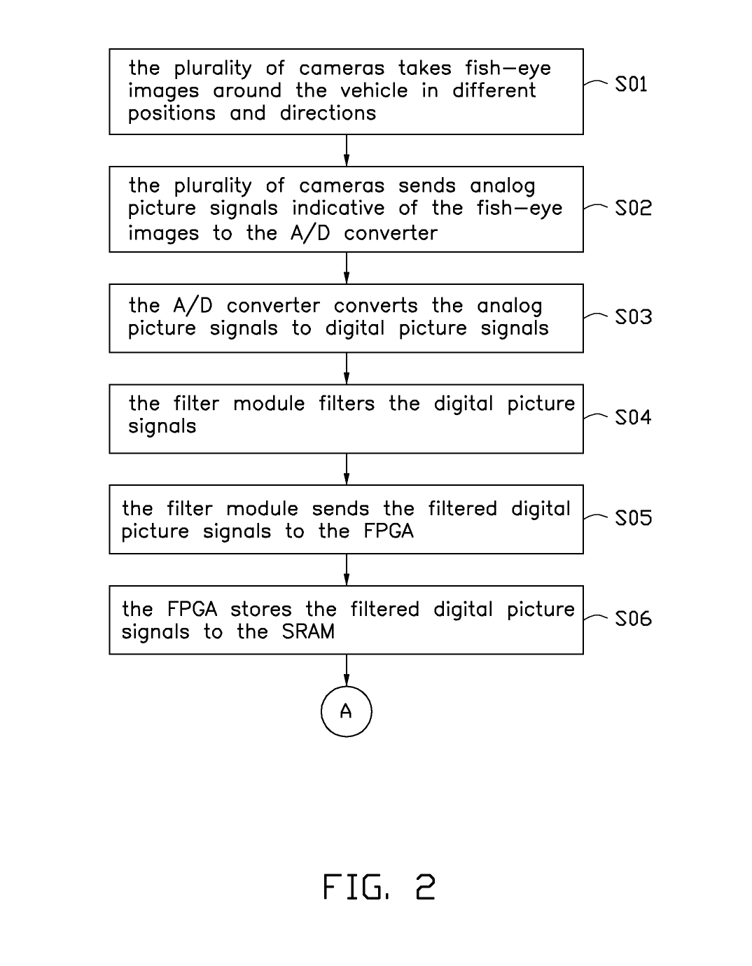

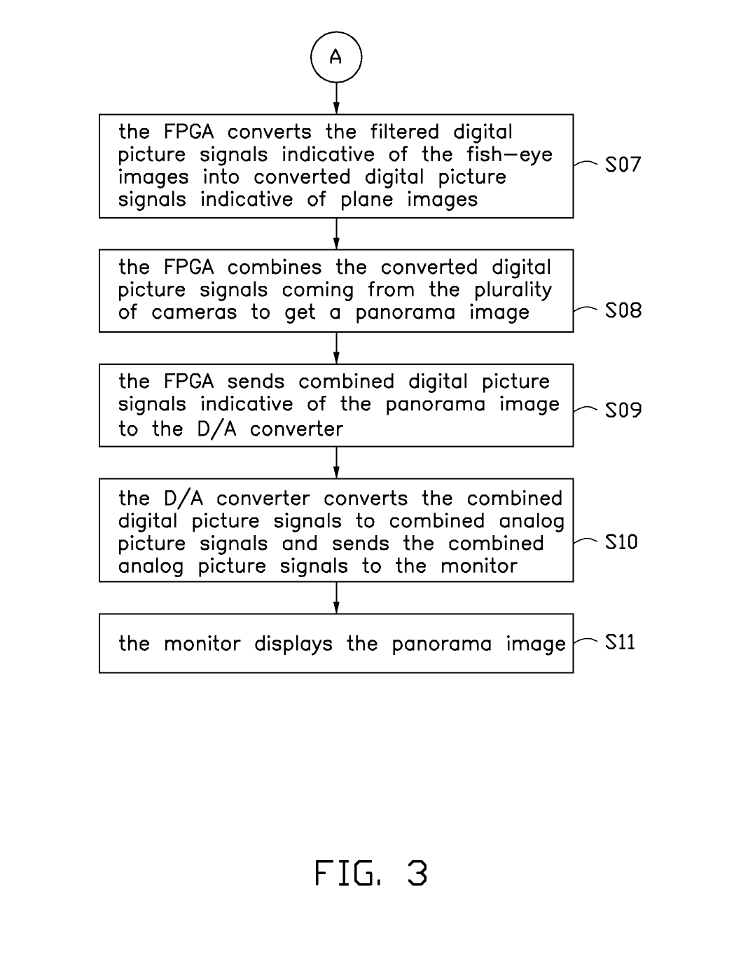

FIGS. 2 and 3 show a flow chart of an embodiment of a driving assistant method based upon the above driving assistant system. The driving assistant method comprises the following blocks.

In block S01, the plurality of cameras takes fish-eye images around the vehicle in different positions and directions.

In block S02, the plurality of cameras sends analog picture signals indicative of the fish-eye images to the A/D converting module 20.

In block S03, the A/D converting module 20 converts the analog picture signals to digital picture signals.

In block S04, the filter module 30 filters the digital picture signals.

In block S05, the filter module 30 sends the filtered digital picture signals to the FPGA 40.

In block S06, the FPGA 40 stores the filtered digital picture signals to the

SRAM 50.

In block S07, the FPGA 40 converts the filtered digital picture signals indicative of the fish-eye images into converted digital picture signals indicative of plane images.

In block S08, the FPGA 40 combines the converted digital picture signals to obtain a panorama image which provides a 360° view around the vehicle. The fish-eye images captured by the plurality of cameras have overlapping areas. In this combining step, the FPGA 40 takes average data of the overlapping areas.

In block S09, the FPGA 40 sends combined digital picture signals indicative of the panorama image to the D/A converting module 70.

In block S10, the D/A converting module 70 converts the combined digital picture signals to combined analog picture signals and sends the combined analog picture signals to the monitor 80.

In block S11, the monitor 80 displays the panorama image.

While the present disclosure has been illustrated by the description of embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, any indication used is only to be viewed for identification purposes and not as a suggestion as to an order for the steps.

What is claimed is:

1. A driving assistant system comprising:
a plurality of cameras configured to capture images around a vehicle in different positions and directions;
a monitor capable of displaying the images; and
a Field-Programmable Gate Array (FPGA) connected to the plurality of cameras, wherein the FPGA combines the images into a panorama image and sends the panorama image to the monitor to display the panorama image.

2. The driving assistant system of claim 1, further comprising an analog-to-digital (A/D) converting module connected to the plurality of cameras and the FPGA, wherein each of the images comprises analog picture signals, the A/D converting module converts the analog picture signals to digital picture signals.

3. The driving assistant system of claim 2, further comprising a filtering module connected to the A/D converting module, wherein the filtering module filters the digital picture signals and sends the filtered digital picture signals to the FPGA.

4. The driving assistant system of claim 1, further comprising a digital-to-analog (D/A) converting module connected to the FPGA and the monitor, wherein the D/A converting module converts digital picture signals outputted from the FPGA to analog picture signals and sends the analog picture signals to the monitor.

5. The driving assistant system of claim 1, further comprising a static random access memory and a dynamic random access memory connected to the FPGA to help the FPGA to store static and dynamic data.

6. The driving assistant system of claim 1, wherein each of the plurality of cameras is a wide-angle lens camera capturing a fish-eye image, and the FPGA is capable of converting the fish-eye image to a plane image.

7. The driving assistant system of claim 6, wherein each of the plurality of cameras is a 170 degrees lens camera.

8. The driving assistant system of claim 6, wherein the plurality of cameras comprises a first camera, a second camera, a third camera, a fourth camera, a fifth camera, and a sixth camera; the first camera and the second camera are attached to two front corners of the vehicle, the third camera and the fourth camera are attached to opposite sides of the vehicle and located adjacent to a central portion of the vehicle, and the fifth camera and the sixth camera are attached to two rear corners of the vehicle.

9. A driving assistant method, comprising:
utilizing a plurality of cameras to capture images around a vehicle in different positions and directions;
combining the images into a panorama image by a Field-Programmable Gate Array (FPGA); and
displaying the panorama image.

10. The driving assistant method of claim 9, wherein each of the captured images is a fish-eye image, and the FPGA converts the fish-eye image into a plane image before combining the images.

11. The driving assistant method of claim 10, further comprising converting analog picture signals of the image to digital picture signals before converting the fish-eye image.

12. The driving assistant method of claim 11, further comprising filtering the digital picture signals and sending the filtered digital picture signals to the FPGA.

13. The driving assistant method of claim 12, wherein the panorama image shows traffic conditions completely around the vehicle.
